(19) United States
(12) Patent Application Publication
(10) Pub. No.: US 2015/0004954 A1
(43) Pub. Date: Jan. 1, 2015

(54) Wireless Communication of Non-Audio Information Between Hearing Devices and Mobile Devices Using Audio Signals

(71) Applicant: Ear Machine LLC, Northbrook, IL (US)

(72) Inventor: Andrew Sabin, Chicago, IL (US)

(21) Appl. No.: 14/316,361

(22) Filed: Jun. 26, 2014

Related U.S. Application Data
(60) Provisional application No. 61/839,614, filed on Jun. 26, 2013.

(51) Int. Cl. H04M 1/725

(52) U.S. Cl. CPC H04M 1/72591; H04M 1/7253
USPC 455/418; 455/557

(57) ABSTRACT

A system, a method, and a peripheral audio device are configured for transmitting non-audio information between a hearing device and a mobile electronic device. The mobile electronic device has a processor and a mobile output frequency range. The hearing device has a processor and an audio output frequency range. The peripheral device has a processor adapted to transmit non-audio information or non-audio signals between the mobile electronic device and the hearing device through the peripheral device. The non-audio information or signals are transmitted as an audio signal. The non-audio information can be embedded in an audio signal that is outside the audio output frequency range of the hearing device but within the mobile device output frequency range, or in the same range but packaged in a way that is inaudible to the human ear. The peripheral audio device can be wirelessly or physically connected to the mobile electronic device and communicates wirelessly with the hearing device.

### RELATED APPLICATION DATA

This patent is related to and claims priority benefit of U.S. provisional application Ser. No. 61/839,614 filed Jun. 26, 2013 and entitled “Wireless Communication of Non-Audio Information Between Hearing Devices and Mobile Devices Using Audio Signals Sent over an Audio Connector”. The entire content of this prior filed application is hereby incorporated herein by reference.

### BACKGROUND OF THE INVENTION

1. Field of the Disclosure

The present disclosure is generally directed to hearing devices, and more particularly to a system, device, and method for wireless communication of non-audio information between a hearing device and a mobile electronic device.

2. Description of Related Art

Hearing devices are known such as hearing aids and personal sound amplifiers. Such devices are worn at or placed near the ears of a user to deliver audio information to the user that has been taken from the user's surroundings and altered. These types of devices typically have various operating parameters that can and must be adjusted for optimal performance and for specific user compatibility. Adjustment of these parameters can be done manually by the user or, more often, a professional service provider familiar with the hearing devices.

Programs, systems, and products have been developed that attempt to make adjustment of the operating parameters of hearing devices easier, user configurable, and less manually cumbersome. For example, one such solution utilizes the dual-tone multi-frequency acoustic tones emitted by a phone to program the performance parameters of a hearing aid. The phone is held close to the hearing aid and then a specific number is tapped or pressed to emit the specific tone for that number. The hearing aid picks up the audible acoustic tone and processes that tone to adjust an operating parameter of the hearing aid. For this solution to work properly, the hearing aid and mobile phone must be in close proximity to one another and the ambient noise level must be such that it does not interfere with the emitted tone being “heard” by the hearing aid device.

### BRIEF DESCRIPTION OF THE DRAWINGS

Objects, features, and advantages of the present invention will become apparent upon reading the following description in conjunction with the drawing figures, in which:

FIG. 1 shows one example of a system and method incorporating a peripheral audio device in accordance with the teachings of the present invention, the peripheral audio device with wired connection to a mobile electronic device and wireless connection to a hearing device.

FIG. 2 shows one example of a system and method incorporating a peripheral audio device in accordance with the teachings of the present invention, the peripheral audio device connected physically to the mobile electronic device.

FIG. 3 shows a plot of the frequency range differential between a mobile electronic device and a hearing device.

FIG. 4 shows the plot of FIG. 3 but with depictions of non-audio information being transmitted outside of the frequency range of the hearing device but within the functional frequency range of the mobile electronic device.

FIGS. 5A-6B show simplified representations of operational parameter adjustments being made to the hearing device but using the mobile electronic device.

### DETAILED DESCRIPTION OF THE DISCLOSURE

The disclosed devices, systems, and methods solve or improve upon one or more of the above-noted and/or other problems and disadvantages of prior known hearing devices. The device is a audio peripheral device that can either be wirelessly connected to a mobile electronic device or physically connected to an audio jack of the mobile electronic device. The peripheral audio device is configured to wirelessly transmit non-audio information between a mobile electronic device to which it is connected and a hearing device. The non-audio information can be processed by the device receiving the non-audio information and converted to data usable at the receiving device. The device can be configured to direct non-audio information to the mobile electronic device from the hearing device, from the hearing device to the mobile electronic device, or both. The non-audio information can be embedded in an audio signal and sent along with audio information but outside of the frequency range of the audio information being transmitted. The non-audio information can also be embedded in the frequency range of the audio information, but presented in a manner such that the non-audio information is not detectable by the human ear. These and other objects, features, and advantages of the disclosed devices, systems, and methods will become apparent to those having ordinary skill in the art upon reading this disclosure.

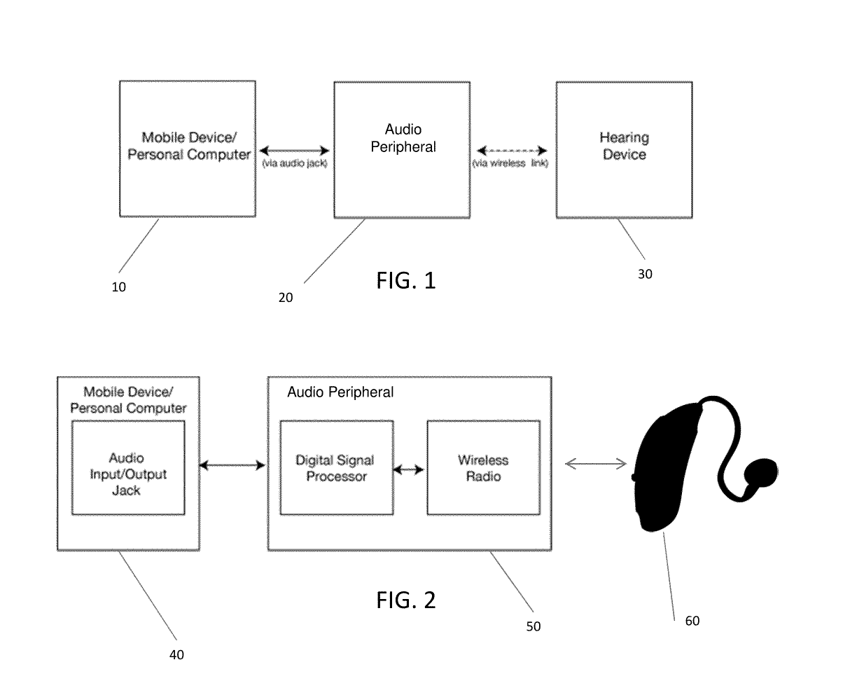

Turning now to the drawings, FIG. 1 shows one example of a system and method according to the teachings of the present disclosure. In this example, the system and method utilize a mobile electronic device 10 is depicted. The mobile electronic device can be a smart phone, a mobile phone, a laptop computer, a tablet device, a desktop computer, a music or MP3 player, or the like. The system and method also utilize a peripheral audio device 20 connected to the mobile electronic device 10. In this example, the peripheral audio device 20 is wirelessly connected to the mobile electronic device 10 via a Bluetooth or other wireless connection. The system and method also employ a hearing device 30, such as a hearing aid, a personal sound amplifier, or the like.

Each of the devices 10, 20, and 30 has its own processor capable of converting and processing data as is known in the art. In one example, the mobile electronic device 10 can transmit non-audio information to the hearing device 30 through the peripheral audio device 20. In another example, the hearing device 30 can transmit non-audio information to the mobile electronic device 10 through the peripheral audio device 20. In another example, the non-audio information can be transmitted in either/both directions by the system and method, as described in greater detail below.

FIG. 2 shows another example of a system and method according to the teachings of the present disclosure. In this example, the system and method utilize a mobile electronic device 40 is depicted. The mobile electronic device can again be a smart phone, a mobile phone, a laptop computer, a tablet device, a desktop computer, a music or MP3 player, or the like. The system and method also utilize a peripheral audio device 50 connected to the mobile electronic device 10. In this example, the peripheral audio device 50 is physically connected to the mobile electronic device 40 via an audio jack. The peripheral audio device 50 can include a male jack or a wire with a male jack that can be inserted into a female audio jack port on the mobile electronic device 40. The system and method also employ a hearing device 60, such as a hearing aid, a personal sound amplifier, or the like.

Again, each of the devices 40, 50, and 60 has its own processor. The system and method of FIG. 2 can again be configured in order that the mobile electronic device 40 can transmit non-audio information to the hearing device 60 through the peripheral audio device 50. In another example, the hearing device 60 can transmit non-audio information to the mobile electronic device 40 through the peripheral audio device 50. In another example, the non-audio information can be transmitted in either/both directions by the system and method, as described in greater detail below.

The transmission of non-audio information by the devices, systems, and methods of the disclosure can include transmitting signal processing parameter values, acoustic feature values, or other operational parameters between hearing devices (such as hearing aids and personal sound amplifiers) and mobile electronic devices (such as smart phones, tablets, and personal computers). The transmitted non-audio information can enable a wide variety of functions that can enhance the user's experience with the hearing device. For example the non-audio information can be used to control the sound quality of the hearing device via changing bass, treble, volume levels, and the like of the hearing device from a mobile electronic device. Likewise, the hearing device can transmit non-audio information to the user's mobile electronic device, such as battery life or the like, giving the user valuable information regarding the status and performance of the hearing device.

This disclosure describes novel systems and methods for transmitting non-audio information between a hearing device and a mobile electronic device. The interface between the hearing device and the mobile electronic device is a peripheral audio device, which has a processor. The peripheral audio device can plug into an audio jack on the mobile electronic device or can be wirelessly connected to the mobile electronic device. The peripheral audio device can be configured to convert audio signals to and/or from wireless programming signals. See FIGS. 1 and 2.

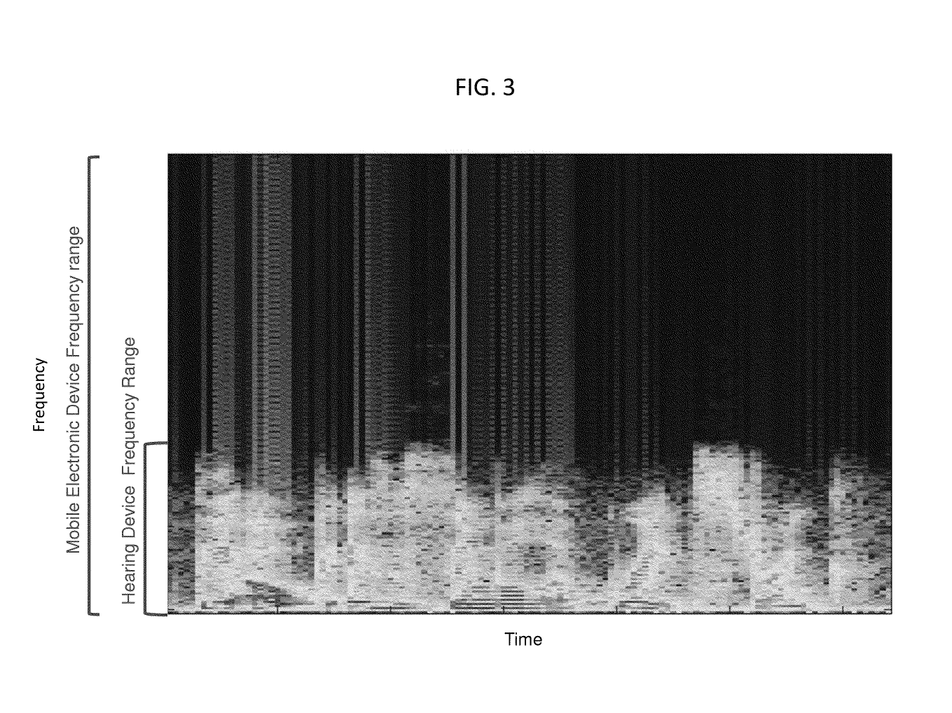

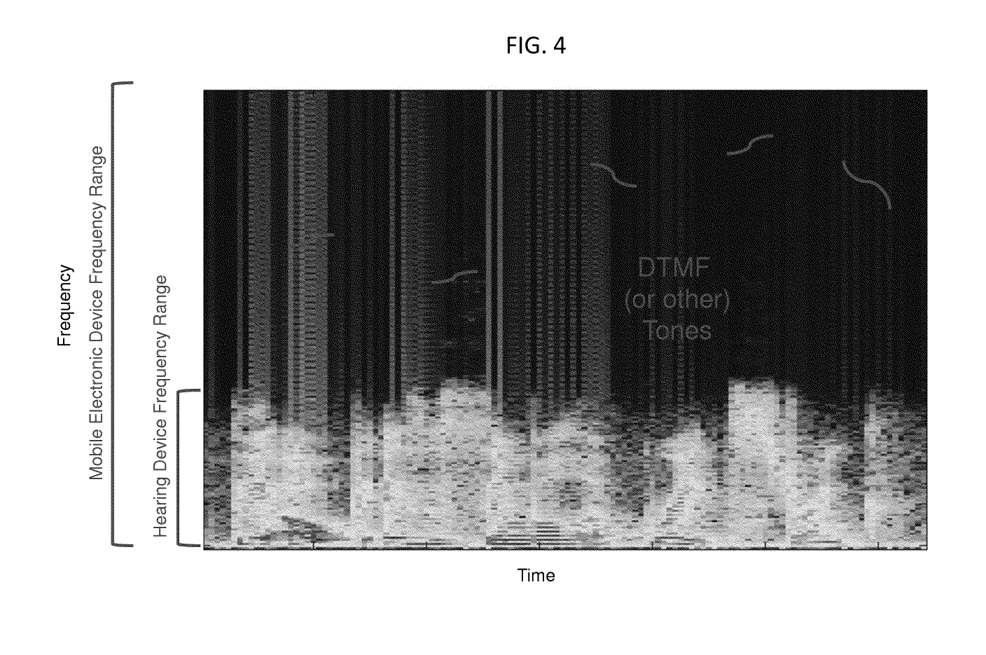

The disclosed system can provide communication in either or both directions. In one direction, non-audio information can be transmitted to the hearing device from the mobile electronic device as an audio signal. An application or program on the mobile electronic device can generate and/or play audio signals that convey the non-audio information. In many instances, these signals can reside in the audio frequency ranges that are above or below the audio frequency range that can be output from the hearing device. For example, as represented in FIG. 3, if the hearing aid has a maximum output frequency of 8 kHz, the application on the mobile electronic device may be capable of generating signals above 8 kHz. If the maximum output frequency of the mobile electronic device 22 kHz, then the signals will necessarily be below this maximum value of the mobile electronic device. See FIG. 4.

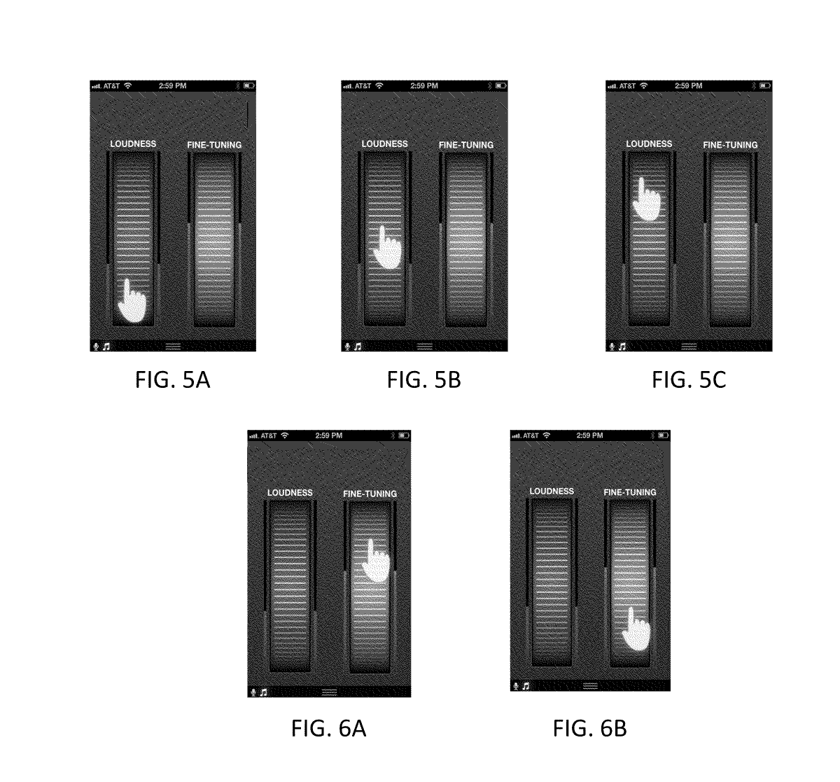

The signals that convey the non-audio information can be designed to encode information such as operational or performance parameter values and parameter types. These parameters can be easily selected and set via an application or program provided on the mobile electronic device. See FIGS. 5A-5C and FIGS. 6A and 6B. The signals can take on many different, optional forms. These can include, but not limited to, the following examples.

1) This non-audio information could be encoded in the signal via a signature pattern of data encoded in dual tone multi-frequency (DTMF) tones.

2) The information could be encoded in the signal via a signature pattern of data encoded in an amplitude and/or frequency modulated tone/noise.

3) The information could be encoded in the signal via a signature spectral pattern of tones/noise.

4) The information could be encoded in the signal via a signature pattern of data encoded in frequency shift-keying (FSK) tones.

In some cases, audio signals generated on the mobile electronic device can be sent out via the analog audio jack of the mobile electronic device. In many cases, this would be a standard 3.5 mm jack on most mobile devices. The peripheral audio device can be connected to the analog audio jack. The peripheral audio device can have at least a digital signal processor and a wireless radio. See FIG. 2. The digital signal processor in the peripheral audio device can be configured to digitize the audio signal via an analog-to-digital converter. The digital signal processor can then convert the audio signals generated by the application into the format that is required for communication with the hearing device.

The converted signal can then be passed to the wireless radio in the peripheral audio device, which can then wirelessly transmit the converted signal to a wireless radio in the hearing device. The hearing device would then receive the signal from the device's wireless radio. The hearing device processor can then decode the signal and apply the information to change one or more parameters of the hearing device.

In the other direction, non-audio information can be transmitted to a mobile electronic device from a hearing device. The hearing device can generate a message and format the message signals for transmission over its wireless radio. The hearing device can then send the signals or message to the wireless radio in the peripheral audio device. The wireless radio in the peripheral audio device can then transmit the signals or message to the digital signal processor in the peripheral audio device. The digital signal processor can take the signals or that message and generate an associated audio signal, such as by using the aforementioned methods 1-4 mentioned above.

The audio signal can then be sent out of and transmitted by the peripheral audio device and into the analog audio input (audio jack) of the mobile electronic device. For example, the audio jack can be the microphone input port of the 3.5 mm headphone jack that is standard on most mobile electronic devices. The program or application on the mobile electronic device can then receive the transmitted audio signal, decode the signal, and apply the information.

In some examples, the passing of audio signals (containing the non-audio information) to and from the peripheral audio device can be handled wirelessly using, for example, a common audio codec such as Bluetooth Advanced Audio Distribution profile (A2DP).

In some examples, the peripheral audio device can be powered entirely from the audio or headphone jack on the mobile electronic device. This power can come from a high-intensity, high frequency tone. Such power is widely used in other applications.

The disclosed approach has several advantages to alternative methods of communication between electronic mobile devices and hearing devices. These advantages include, but are not limited to:

1) Transfer of information is wireless.

2) Most mobile electronic devices, audio devices, and personal computers have an analog audio jack, so a single peripheral audio device can work on a wide range of mobile electronic devices.

3) The disclosed systems and methods do not require the use of wireless radios that are built into the mobile electronic device, which can vary greater in terms of protocol and availability.

4) The communication also may not require charging an additional piece of hardware.

5) The communication does not require any transmission of a signal in the acoustic domain.

Although certain systems, methods, and devices have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A method for transmitting non-audio information between a hearing device and a mobile electronic device, the method comprising:
providing a mobile electronic device having a processor;
providing a hearing device having a processor;
providing a peripheral device having a processor and connected to the mobile electronic device; and
transmitting non-audio information between the mobile electronic device and the hearing device through the peripheral device, the non-audio information being transmitted as audio information or as an audio signal.

2. The method according to claim 1, wherein the non-audio information is transmitted from the mobile electronic device to the hearing device.

3. The method according to claim 1, wherein the non-audio information is transmitted from the hearing device to the mobile electronic device.

4. The method according to claim 1, wherein the non-audio information can be transmitted from the hearing device to the mobile electronic device and from the mobile electronic device to the hearing device.

5. The method according to claim 1, wherein the non-audio information includes operational parameters of the hearing device.

6. The method according to claim 1, wherein the non-audio information is encoded in a signal via a signature pattern of data encoded in dual tone multi-frequency tones.

7. The method according to claim 1, wherein the non-audio information is encoded in a signal via a signature pattern of data encoded in an amplitude modulated tone/noise.

8. The method according to claim 1, wherein the non-audio information is encoded in a signal via a signature spectral pattern of tones or noise.

9. The method according to claim 1, wherein the non-audio information is encoded in a signal via a signature pattern of data encoded in frequency shift-keying tones.

10. The method according to claim 1, wherein the peripheral audio device is connected to the mobile electronic device via a wireless connection.

11. The method according to claim 1, wherein the peripheral audio device is physically connected to the mobile electronic device via an audio jack or audio jack port.

12. The method according to claim 1, wherein the non-audio information is transmitted outside of an audio output frequency range of the hearing device but within a mobile device output frequency range of the mobile electronic device.

13. The method according to claim 12, wherein the non-audio information is transmitted above a maximum audio signal threshold of the audio output frequency range but below a maximum audio signal threshold of the mobile device output frequency range.

14. A device for transmitting non-audio information between a hearing device and a mobile electronic device, the device comprising:
a digital signal processor; and
a wireless radio,
wherein the digital signal processor is configured to i) digitize audio signals from a hearing device or a mobile electronic device via an analog-to-digital converter, ii) convert the digitized audio signals into a format required for communication with the hearing device or the mobile electronic device, iii) pass the converted digitized audio signals to the wireless radio, and iv) wirelessly transmit the converted digitized audio signals to another wireless radio of the hearing device or the mobile electronic device.

15. A system for transmitting non-audio information between a hearing device and a mobile electronic device, the system comprising:
a mobile electronic device having a processor;
a hearing device having a processor; and
a peripheral audio device having a processor and a wireless radio adapted to transmit non-audio signals or non-audio information between the mobile electronic device and the hearing device through the peripheral audio device, the non-audio signals or non-audio information being transmitted as audio information or audio signals.
